(19) United States
(12) Patent Application Publication
(10) Pub. No.: US 2012/0040063 A1
(43) Pub. Date: Feb. 16, 2012

(54) Dual Pie Crust Bag, Kit and Method

(76) Inventor: Maxine C. Wagner, Kent, WA (US)

(21) Appl. No.: 13/208,226

(22) Filed: Aug. 11, 2011

Related U.S. Application Data
(60) Provisional application No. 61/372,578, filed on Aug. 11, 2010.

(51) Int. Cl. A21D 8/02; A23P 1/10; A21C 9/08

(52) U.S. Cl. 426/391; 425/458

(57) ABSTRACT

A disposable bag used to make a lower and upper crusts for a circular pie. The bag is square or rectangular, and is sufficient in width and length to hold a pre-cooked, 11 inch circular or rectangular pie. The bag is made of disposable, FDA food approved plastic film with a top layer and a bottom layer that are registered and partially sealed along its perimeter edges. A section of the edges of the bag are detached thereby forming a large opening into the bag allows a pie pan to be easily inserted into the bag. Formed on the top layer is a centrally perforated line can be easily torn to allow the bag's top layer to be unfold so that the flat dough configuration used to make the upper crust may be easily removed and aligned over a pie. Imprinted on the outside surface of the top layer are one or two, centrally aligned pie pan crust templates that the user uses to make flat dough configurations with the proper diameters for the upper and lower crusts on a pie, respectively. Using the above bag, a method for manufacturing a pie is also disclosed.

This utility patent application is based on and claims the filing date benefit of U.S. provisional patent application No. 61/372,578, filed on Aug. 11, 2010.

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention relates to devices and methods for making upper and lower pie crusts.

2. Description of the Related Art

Many pies have a lower crust and an upper crust. Many individuals find pie crusts that are light and flaky, have uniform thickness, and visually appetizing, most desirable.

Pies are typically made in shallow, circular, 9 to 11 inch diameter pie pans. When a cook makes a pie, two balls of dough are created for the upper crust and the lower crust. Each ball of dough is then manually molded into a circular, flat configuration using a cutting board, a rolling pin, a sheet of wax paper and flour. To make the crust ‘flaky’, it is important that the precise amount of ingredients be used. It is also important the that dough be knelled an optimal amount and not ‘overworked’, and that it be pressed into a flat configuration while cool to minimize adhesion to the cook's hand, wax paper or rolling pin.

After flattening, the dough for each pie crust is circular. The diameter of the lower pie crust is approximately 2 inches longer than the diameter of the dough for the upper pie crust because the lower pie crust must cover the bottom and side walls of the pie pan. Also, because the upper crust is visible, greater care is usually taken to align the edges of the upper and lower crusts and to prevent tears or visual imperfections in the upper pie crust.

### SUMMARY OF THE INVENTION

It is an object of the present invention to provide device that enables a cook easily manufacture a pie with two coaxially aligned pie crusts formed over a circular pie pan that does not require special cooking utensils or tools that take up valuable space in pantry or drawer in a kitchen.

It is an object of the present invention to provide such a device that is relatively inexpensive, disposable after one use and can be safely used by cooks of all ages.

It is an object of the present invention to provide a device used to roll one or two balls of crust dough into flat configurations that can then be used to make upper and lower pie crusts for use on a pie.

It is another object of the invention to provide such a device that allows two flat circular pie crusts to be easily coaxially aligned over a circular pie pan easily and quickly without excessive mess.

It is further object of the present invention to provide a method to easily align the upper crust over the lower crust and to prevent tears or imperfections in the upper crust.

These and other objects are met by a disposable bag used to make pie crusts. The bag is made of thin, flexible, FDA approved plastic that, when placed on a horizontal surface, is sufficient in width and length to hold at least a circular 11 inch diameter pie. The bag is square or rectangular and includes a top layer and a bottom layer that are sealed together along three perimeter edges. The perimeter edges on one side of the bag are detached, thereby forming a large side opening that allows a pie pan to be easily placed into and removed therefrom. The side opening may also include an optional sealing edge that enables the side opening to be selectively closed and sealed for temporarily storing the balls or flat configurations of dough for chilling in a refrigerator.

Formed on the top layer of the bag is a perforated line that can be easily torn to allow a prepared pie to be easily removed from the bag. Imprinted of the top layer are one or two, centrally aligned pie pan outlines to help the user make the two flat dough's for a 11 inch pie pan. An optional pie dough recipe may also be imprinted on the top surface on the bag.

The bag may be distributed individually or sold with a plurality of bags in an outer container.

Using the above bag, a method for manufacturing a pie is also disclosed.

### DESCRIPTION OF THE DRAWINGS

FIG. 1 is a perspective view of a pie in a pie pan that includes an upper crust laye, filling, and a lower crust layer.

FIG. 2 is a top plan view of the bag showing two balls of dough being placed therein.

FIG. 3 is an illustration showing an upside down pan being placed into the bag shown in FIG. 2.

FIG. 4 is a top plan view of the bag with the top layer being folded over and disclosing a flat upper pie crust located therein and the user's hand being positioned under the bag's bottom layer.

FIG. 5 is a perspective view of a large container holding a plurality of bags.

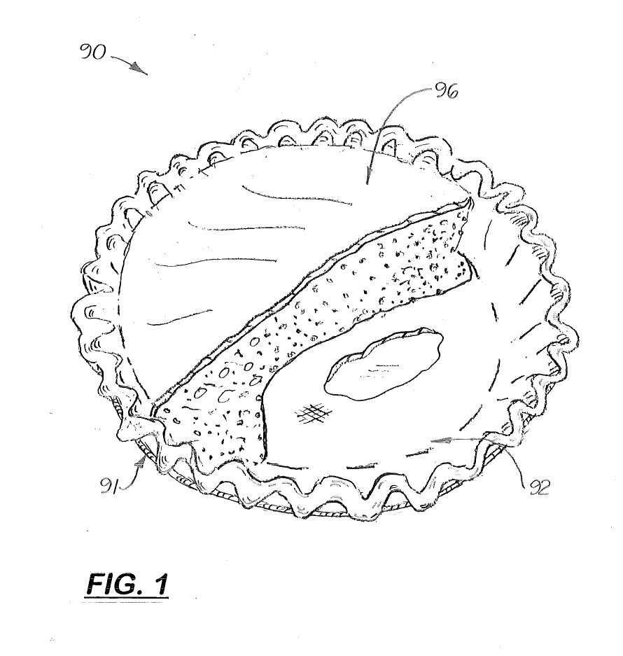

### DESCRIPTION OF THE PREFERRED EMBODIMENT(S)

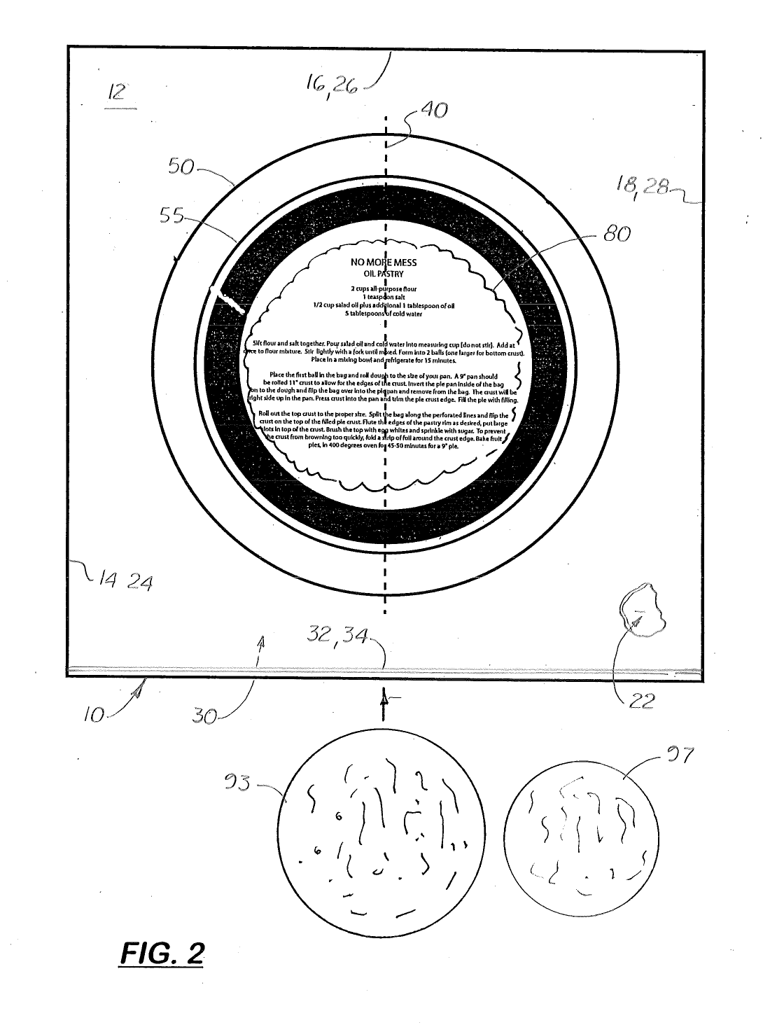

Referring to the accompanying Figs. there is shown a disposable bag 10 used to make lower and upper crusts 92, 96, respectively, for a circular pie 90. The bag 10, shown more clearly in FIGS. 2-4, is made of thin plastic film and sufficient in width and length to received a pie 90 disposed over the inside surface of the bag's bottom layer 22. The bag 10 is square or rectangular structure that includes a planar top layer 12 and a planar bottom layer 22 that are sealed together along their perimeter edges 14,16, 18, and 24, 26, 28, respectively. The fourth edges 19, 21 of the top and bottom layers 12, and 22, are detached, thereby forming a large side opening 30 into the bag 10 so that allows a 11 inch circular pie pan 91 to be easily placed into and removed therefrom. The detached edges of the top and bottom layers 12, 22, respectively may include optional sealing gutters 32, 34 that enables the side opening 30 to be selectively closed for temporarily storing the balls 93, 97 or flat configurations 92, 97 of dough in a refrigerator.

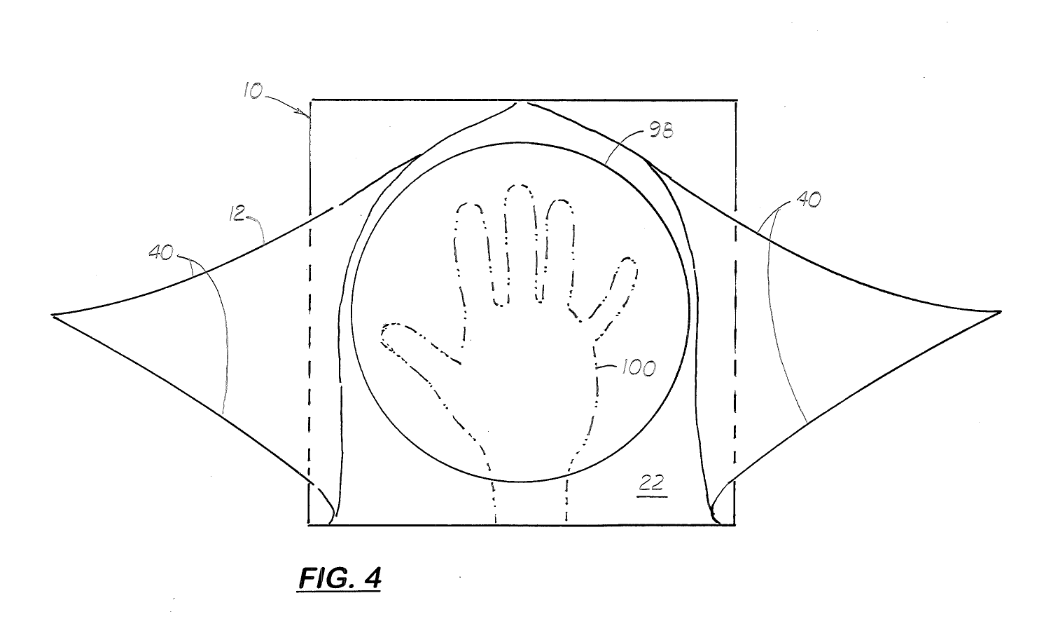

As shown in FIG. 2, formed on the top layer 12 is a centrally, transversely aligned perforated line 40 can be easily torn to allow top layer 12 to be opened and unfolded (see FIG. 4) so that the flat configuration dough 96 ration used for the upper crust 96 may be easily aligned and deposited over the pie pan 91. Imprinted on the outside surface of the top layer 12 are one or two, centrally aligned pie pan outlines or templates 50, 55 that the cook uses to coaxially align the two flat circular configured doughs 93, 97 over the pie pan 91. An optional pie crust recipe and cooking instructions indicia 80 may be printed on the top layer 12.

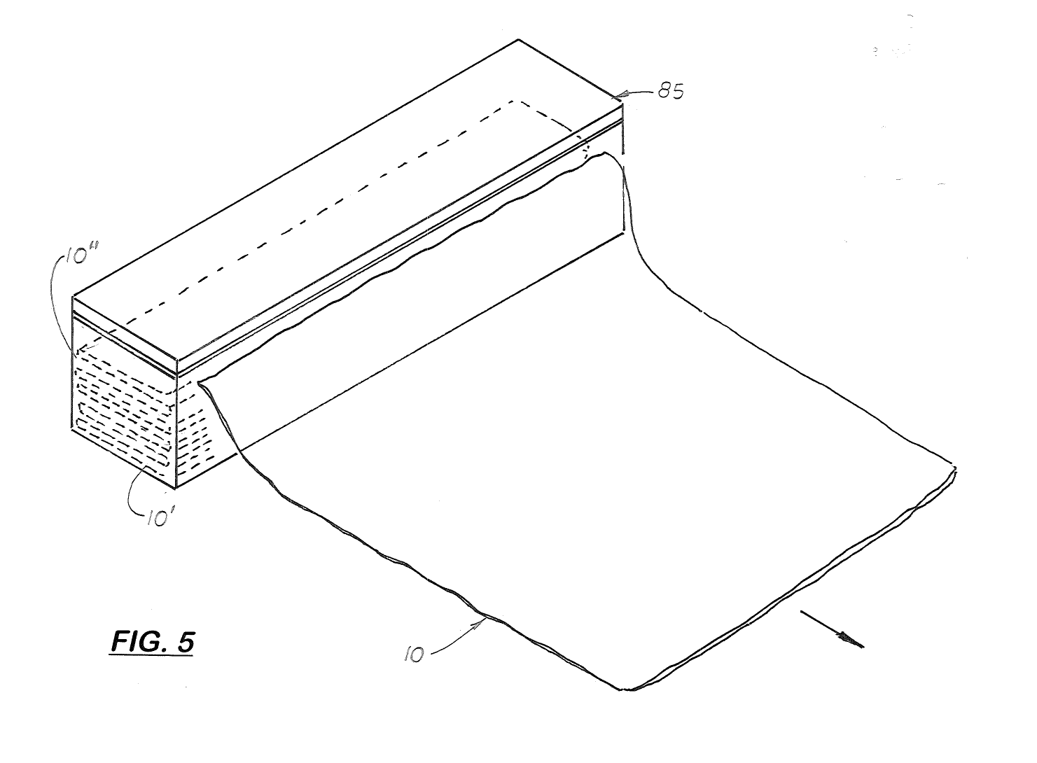

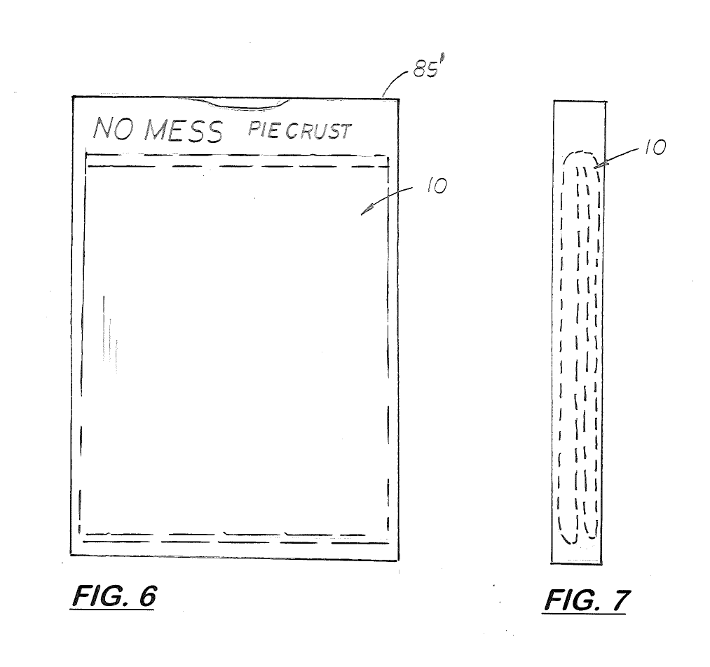

The bag 10 may be distributed as a kit 11 containing a plurality of bags 10′, 10″ in an outer large container 85 as shown in FIG. 5 or distributed individually 10 in an outer smaller container 85.

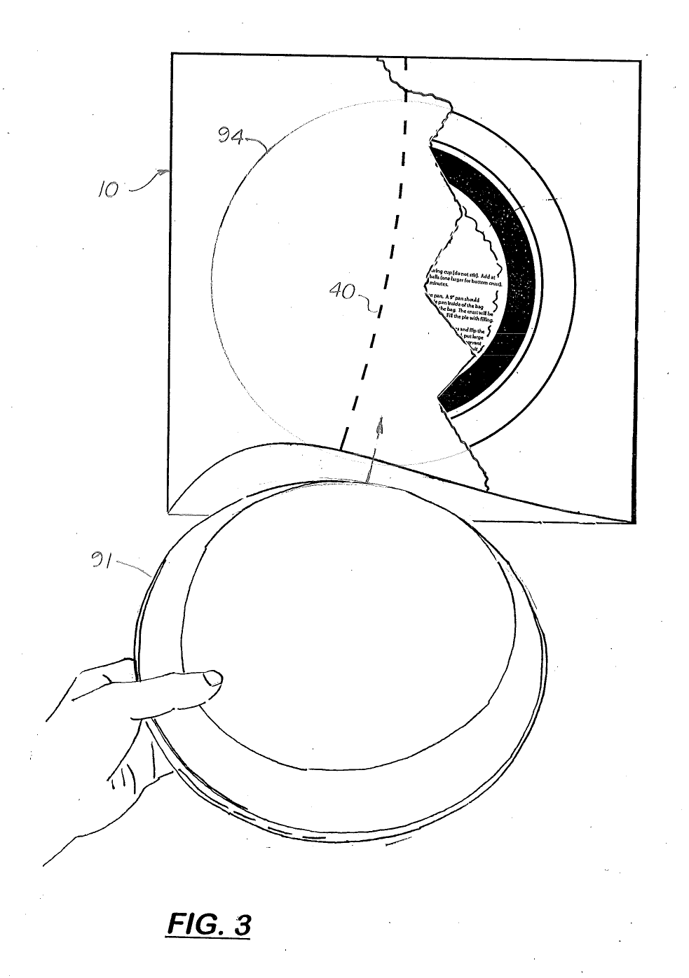

During use, a large ball of pie dough 93 for the lower pie crust 92 and a small ball of pie dough 97 for an upper pie crust 96 are prepared. The bag 10 is then unfolded and positioned on a flat countertop or food preparation area with the outside surface of the top layer 12 facing upward as shown in FIG. 2. If the balls 93, 97 have reached room temperature, they may be inserted into the bag 10 which is then placed in a refrigerator the lower their temperatures. Once cooled, the larger ball of pie dough 93 is then selected and inserted through the side opening 30 and placed in a central location inside the bag 10 and centrally aligned under the large pan template 50 when provided. The top layer 12 of the bag 10 is then forcibly pressed against the ball of pie dough 93 molding it into a large flat dough configuration 94 as shown in FIG. 3.

After the large flat dough configuration 94 has been formed, the pie pan 91 is then selected and turned upside down and into the bag 12 as shown in FIG. 3. The pan 91 is coaxially aligned over the large flat dough configuration 94. The bag 12 with the large flat dough configuration 94 and the pie pan 91 are then flipped over 180 degrees so that the large flat dough configuration 94 is supported by the outer rim on the pie pan 91. The pie pan 91 and large flat dough configuration 94 are then removed from the bag 12. The large flat dough configuration 94 is then manually forced downward into the pan 91 to form the lower crust 92.

The bag 12 is then repositioned on the flat countertop with the top layer 12 facing upward. Next, the small ball of dough 97 is selected and inserted through the side opening 30 and placed in a central location inside the bag 12. The top layer 12 of the bag 10 is then forcibly pressed against the ball of dough 97 molding it into a flat dough configuration 98 that matches the small pie crust template 55. After the flat dough configuration 98 has been formed, the bag 12 is then opened and unfolded along the perforated line 40 thereby exposing the flat dough configuration 98. The user then places his or her hand 100 under the bottom layer 22 of the bag 10 and positions the bag 12 over the pie pan 91 and then rotates the bag 10 so that the upper crust layer falls through the top opening and onto the pie pan 91 filled with filling as shown in FIG. 4 The perimeter edges of the upper crust 96 and the lower crusts 92 are then joined and molded in the desired crust edge decorative design.

The bag 10 is made of FDA approved, thin (1 mil), virgin, polyethylene and measures approximately 15 inches long and 15 inches wide. In the preferred embodiment, bag 10 is made of at least partially transparent material so that the balls 94, 97 and flat dough configurations 96, 98 may be seen through the top layer 12. The joined perimeter edges of the top and bottom layers 12, 22, respectively, are heat or radio frequency welded together.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A disposable bag for making upper and lower pie crusts coaxially aligned over a circular pie pan, comprising:
a. a top layer and a bottom layer stacked together, said layers being sealed together along three perimeter edges with one edge detached thereby forming a large side opening into said bag that allows a pie pan to be easily placed into and removed therefrom;
b. a centrally perforated line formed on said top layer can be easily torn to allow said top layer to be opened and unfold so that a flat configured pie crust formed inside said bag so that when said bag is rotated so that said top surface and said perforated line are facing downward and coaxially aligned over a pie pan said flat upper crust pie dough falls and is deposited directly over said pie pan, and;
c. a first pie crust template formed on said top layer of said bag, said first pie pan crust template having a diameter that is the same as the lower or upper pie crust configured to be coaxially aligned and having the same diameter of a pie pan.

2. The disposable bag, as recited in claim 1, further including a second pie crust template configured on said top layer.

3. The disposable bag, as recited in claim 1, wherein said bag is made of transparent or semi-transparent material.

4. The disposable bag, as recited in claim 1, wherein said bag is made of food contact regulated plastic.

5. The disposable bag, as recited in claim 1, further including pie crust recipe and pie cooking instructions indicia may be printed said bag.

6. The disposable bag, recited in claim 1, further including an outer container for storing said bag in a compact configuration.

7. A dual pie crest kit, comprising:
a. a disposable plastic bag configured to hold a circular pie pan, said bag includes a top layer and a bottom layer sealed together along three perimeter edges with one edge detached thereby forming a large side opening into said bag that allows a pie pan to be easily placed into and removed therefrom, said;
b. a centrally perforated line formed on said top layer can be easily torn to allow said top layer to be opened and unfold so that a flat configured pie crust formed inside said bag so that when said bag is rotated so that said top surface and said perforated line are facing downward and coaxially aligned over a pie pan said flat upper crust pie dough falls and is deposited directly over said pie pan;
c. a first pie crust template and a second pie crest template coaxially aligned on said top layer of said bag, said first pie pan crust template having a diameter that is the same as the lower pie crust and said second pie crest template that is the same as the upper pie crust; and,
d. an outer container for storing said bag in a compact configuration.

9. The disposable bag, as recited in claim 8, further including pie crust recipe and pie cooking instructions indicia may be printed said bag.

10. A method for making upper and lower pie crusts from two balls of dough, comprising the following steps:
a. selecting a bag;
b. unfold and position said bag on a flat countertop or food preparation area with the outer surface of the top layer facing upward;
c. selecting a ball of pie dough for the lower pie crust and placing said ball in a central location inside the bag;
d. forcing said top layer of the bag forcibly against said ball to mold it into a flat configuration;
e. selecting a pie pan and rotating said pan upside down and coaxially aligned said pan over the flat dough;
f. flipping said bag and said flat dough 180 degrees so that the lower pie crust is extended and supported by the outer rim on the pie;
h. removing said pie pan and crust from said bag and forcible pressing said pie crust into said pan;
i. selecting a small ball used to make the upper pie crust;
j. forcing said top layer of the bag forcibly against said ball to mold it into a flat configuration;
k. opening and unfolding said bag along the perforated line so that the upper crust pie layer is exposed; and,
l. rotating said bag and said pie crust so that said upper crust layer may fall over the pie pan.
